(19) United States
(12) Patent Application Publication
(10) Pub. No.: US 2025/0272598 A1
(43) Pub. Date: Aug. 28, 2025

(54) ENHANCED NORMALIZATION FOR LOW-BIT NEURAL NETWORKS

(71) Applicant: QUALCOMM Incorporated, San Diego, CA (US)

(72) Inventors: Jian SHEN, San Diego, CA (US); Jamie Menjay LIN, San Diego, CA (US)

(21) Appl. No.: 18/584,568

(22) Filed: Feb. 22, 2024

(51) Int. Cl. G06N 20/00

(52) U.S. Cl. CPC G06N 20/00

(57) ABSTRACT

Certain aspects of the present disclosure provide techniques and apparatus for improved machine learning model operations. Embodiments include accessing a value encoded with a sign bit and performing an operation using the value within a machine learning model. A result of the performance of the operation may be encoded with no sign bit based on a type of the operation.

Aspects of the present disclosure relate to machine learning.

Machine learning models may be used to process a variety of data, and various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), etc.), random forest models, and the like. Increasingly, machine learning models are being used in a variety of image and video processing tasks, natural language processing, or other tasks in which data is processed in order to generate various inferences related to the data.

Machine learning models may be deployed on various devices, such as server computing systems, personal computing systems (e.g., laptop computers, desktop computers, etc.), and/or other computing systems on which machine learning models can be executed. However, because these machine learning models may include various computationally expensive components, the universe of devices on which these machine learning models can be deployed may be limited, and inferencing operations on devices on which these machine learning models are deployed may use significant amounts of available computing resources.

### BRIEF SUMMARY

Certain aspects provide a method, comprising: accessing a value encoded with a sign bit; and performing an operation using the value within a machine learning model, wherein a result of the performance of the operation is encoded with no sign bit based on a type of the operation.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example workflow for improved machine learning model operations through a flexible sign bit according to various aspects of the present disclosure.

FIG. 2 illustrates an example of improved machine learning model operations through a flexible sign bit according to various aspects of the present disclosure.

FIG. 3 illustrates an example of an enhancement for improved machine learning model operations through a flexible sign bit according to various aspects of the present disclosure.

FIG. 4 is a flow diagram depicting an example method for improved machine learning model operations through a flexible sign bit according to various aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for improved machine learning model operations through a flexible sign bit.

In machine learning models, such as neural networks, various functions can be used to generate a normalized output from the model. These functions may include, for example, a softmax activation function (in which the output is scaled to values between 0 and 1) or other activation functions which can be used to restrict the output of the machine learning model to values between some defined minimum and maximum values. In many cases, these functions and other operations performed by machine learning models may be computationally expensive, and thus, to allow for machine learning models to be deployed on a wide variety of computing devices, various techniques can be used to reduce computing resources utilized by machine learning models.

For example, values may be stored with limited bit widths in order to limit the amount of computational resources used to store and process such values within machine learning models. 4-bit integer (INT4), 8-bit integer (INT8), 16-bit floating point (FP16), and the like are formats that represent values using a limited number of bits. Such formats provide different representable ranges based on how many values can be uniquely represented by available combinations of bits. Accordingly, “saturation” can occur, meaning that all values above the maximum representable value or below the minimum representable value are represented by that maximum or minimum representable value. Saturation can be tolerated in machine learning models due to the ability of such models to adapt to saturation, but is not preferable due to the reduction in accuracy that results.

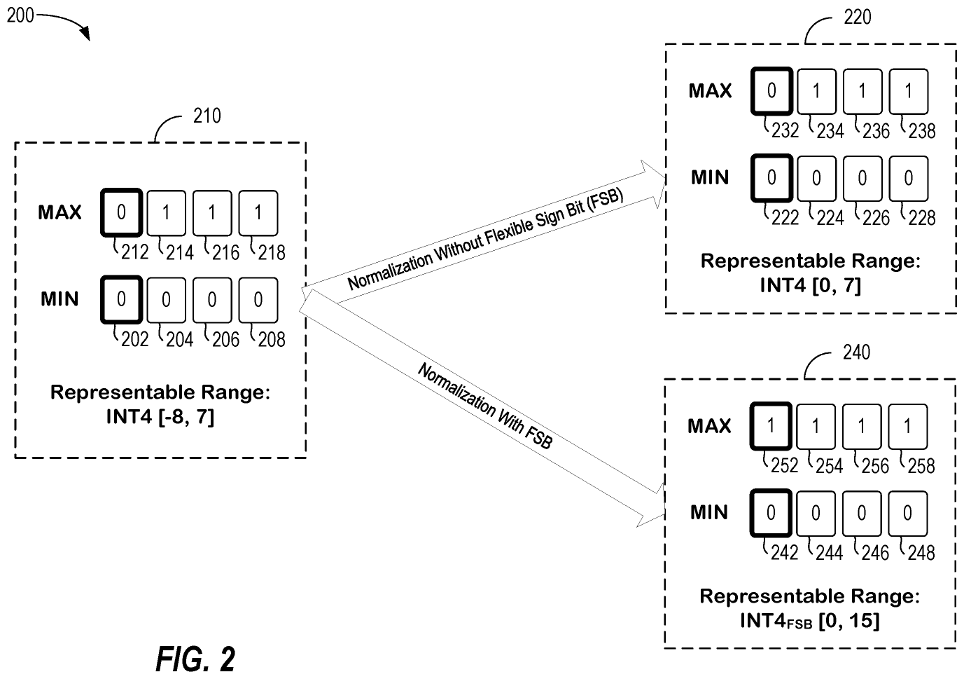

In many cases, formats used to represent numerical values include a sign bit for representing a positive or negative sign. For example, an INT4 format may include one bit for a sign and three bits for a value. However, in some cases, an operation performed within a machine learning model may be of a type that produces only non-negative values as results. For instance, square operations and absolute value operations produce only non-negative results. Thus, representing the results of such operations with a format that uses one bit reserved as a sign bit provides an unnecessarily restrictive representable range, as explained in more detail below with respect to FIG. 2.

Saturation frequently occurs in such cases due to the limited representable range, and a loss in model accuracy results. Saturation can be reduced in some cases through the use of a larger bit width for representing values, but the use of larger bit widths entails larger computational resource costs, including larger amounts of memory, processing, and power resources. When larger bit widths are used only for particular values that are likely to exceed a representable range of a smaller bit width (e.g., and the smaller bit width is used for other values), the additional bit width for such values may not be budgeted for in the machine learning model, and the accuracy of such a machine learning model may be negatively impacted as a result.

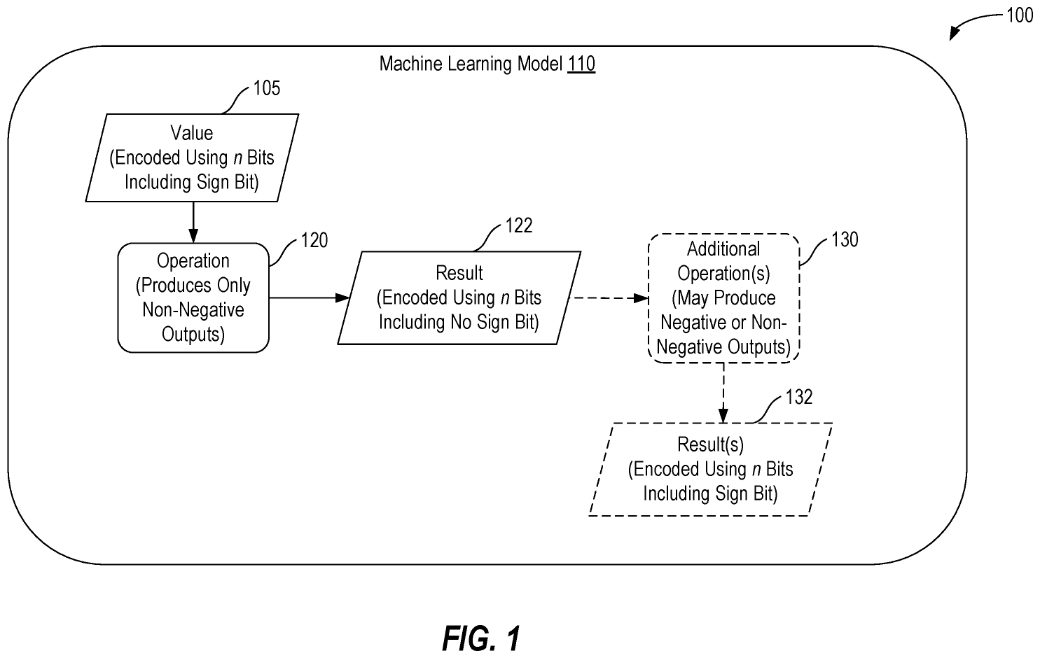

Techniques described herein may help address this problem through the use of a flexible sign bit that is used as either a sign bit or another bit for representing numerical values depending on the operation. Such techniques may be used for both fixed point (e.g., INT8) and floating point (e.g., FP16) formats. In particular, as described in more detail below with respect to FIG. 1, certain aspects involve representing results of operations that produce only non-negative results without using any available bits as sign bits, and instead utilizing all available bits for unsigned representations of results of such operations. For example, if an INT4 format is used within a machine learning model, then all 4 bits may be used to represent a numerical value that results from an operation that produces only non-negative results. Otherwise, one of the bits may be used as a sign bit when representing the results of operations that do not produce only non-negative results.

Using a flexible sign bit for representing numerical data (e.g., without representing the sign) in such cases enables a greater representable range with respect to the set of all possible results from such operations (e.g., which includes only non-negative numbers).

Normalization operations in machine learning models are often of a type that produce only non-negative results. For example, each of the following normalization functions produces only non-negative results:

$$L 2 - norm : {‖ X ‖}_{2} = \sqrt{{\sum }_{i} {x}_{i}^{2}} ;$$

$$L 1 - norm : {‖ X ‖}_{1} = \vert X \vert = {\sum }_{i} \vert {x}_{i} \vert ; and$$

$$L ∞ - norm : {‖ X ‖}_{∞} = {max}_{i} \vert {x}_{i} \vert .$$

L2-norm, shown above, produces only non-negative results because its ultimate output is a result of a square root operation (which can produce only non-negative results). L1-norm, shown above, produces only non-negative results because its ultimate output is a summation of results of an absolute value operation (which can produce only non-negative results). L co-norm, shown above, produces only non-negative results because its ultimate output is a maximum of results of an absolute value operation (which can produce only non-negative results). Thus, each of these normalization operations are examples of operations that produce only non-negative results, and for which all available bits could be used to represent a numerical value without the need to encode the result with a sign bit according to aspects of the present disclosure (providing greater range or finer granularity). Other normalization techniques, such as batch normalization (also referred to as “batch norm”), layer normalization (also referred to as “layer norm”), instance normalization (also referred to as “instance norm”), and group normalization (also referred to as “group norm”), may also involve operations that produce only non-negative results.

In some cases, a new instruction may be used to implement techniques described herein, such as an instruction for performing normalization operations that involve a square (or other operation that produces only non-negative results, such as absolute value operations). Such an instruction may involve using the bit that would otherwise be used as a sign bit as an additional bit for representing a numerical value that results from performing such an operation.

Dynamically determining whether to encode values with a sign bit based on the type of operations used to produce the values allows for a greater representable range, reduced instances of saturation, and a corresponding increase in machine learning model accuracy without the need to use a larger bit width to represent such values (which may consume larger amounts of memory, processing, and power resources to represent, store, and/or process such values and/or may create additional overhead to support differing bit widths within the same model). Accordingly, techniques described herein constitute a technical improvement over conventional techniques for representing, storing, and/or processing values in machine learning models through increased representational power and increased model accuracy with reduced memory, processing, and power resource utilization.

Furthermore, in some aspects, the effects of saturation in machine learning models may be further reduced through an enhanced square instruction involving monotonically increasing a value through a formula after exceeding a largest value of which a square can be represented using the available bits. For example, in the case of INT8, even without using any of the 8 bits as a sign bit, the maximum value that can be represented is 255, and so the largest value the square of which can be represented is 15 (e.g., because 15\hat{ }2=225, which can represented using INT8, but 16\hat{ }2=256, which cannot be represented using INT8). Thus, if the input to a square operation is less than or equal to 15, the result of the square operation can be represented using INT8. However, if the input to a square operation is greater than 15, the result of the square operation will saturate at 255 (e.g., the maximum value that can be represented using INT8) without any differentiation between such values.

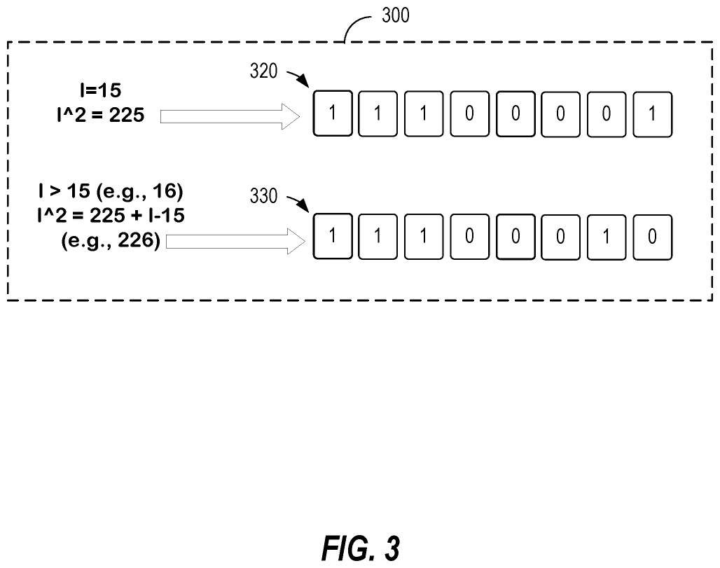

Accordingly, as described in more detail below with respect to FIG. 3, a square instruction (e.g., for performing a square operation within a machine learning model, such as during a normalization process) may involve determining whether the input I to the square operation is greater than a maximum value B the square S of which can be represented by the bit width being used (without using any bits as a sign bit). If the input I to the square operation is not greater than the maximum value B the square S of which can be represented by the bit width being used, then the input I may be squared and the result of the square operation may be stored as-is without a sign bit. However, if the input I to the square operation is greater than the maximum value B the square S of which can be represented by the bit width being used, then the following formula may be used to compute the result of the square operation:

$$I \hat{} 2 = S + I - B .$$

In an example of an INT8 format, the largest value the square of which can be represented is 15 (e.g., B=15), and the square of that value is 225 (e.g., S=225). In this example, if the input to the square operation is 16 (e.g., I=16), then computing the square operation (I\hat{ }2) may involve determining that I is greater than B (e.g., 16 is greater than 15) and, based on this determination, computing the result of the square operation using the formula I\hat{ }2=S+I−B, rather than simply squaring I. Thus, in this example, the result of the square operation is:

$$225 + 16 - 15 = 226 ,$$

which may be stored without using any bits as a sign bit. Similarly, in another example, if I=17, then the result of the square operation may be computed as:

$$225 + 17 - 15 = 227 ,$$

which may be stored without using any bits as a sign bit. Thus, using this enhanced square instruction, the machine learning model may be enabled to capture at least some amount of differentiation between results of square operations of values that exceed the maximum value the square of which can be represented by the bit width being used, rather than having all such results be saturated at the maximum representable value without differentiation. Accordingly, this enhancement further increases the accuracy of the machine learning model without requiring the use of a larger bit width and the consequent costs in memory, processing, and power resources.

Techniques described herein are particularly advantageous in lower bit width formats, such as 2-bith integer (INT2) and INT4, and for low-power use cases, such as always-on sensors, on-device learning, and low-bit networks, due to the increased representational power with reduced memory, processing, and power resource consumption. Aspects of the present disclosure may be utilized to improve both training and inference stages with machine learning models, particularly during normalization processes. For INT2, techniques described herein increase the representable range of non-negative values from [0,1] to [0,3], which is a 200% increase. For INT4, techniques described herein increase the representable range of non-negative values from [0,7] to [0,15], which is a 114% increase. For INT8, techniques described herein increase the representable range of non-negative values from [0,127] to [0,255], which is a 100% increase. In all of these cases, the increase in representational power is achieved while avoiding the additional resource costs that would otherwise be incurred to increase the bit width in alternative techniques.

Aspects of the present disclosure may be used in neural signal processors (NSPs), such as being implemented via one or more NSP instructions. Aspects may also be used with other type of processors and in various types of machine learning contexts, such as stereo depth or optical flow estimation, autonomous driving, mobile cameras, augmented reality and virtual reality, and/or the like. Furthermore, machine learning models described herein may be any type of machine learning model in which operations are performed that produce only non-negative results, such as (for one example) transformer neural networks that use normalization processes described herein.

### Example Workflow for Machine Learning Model Improvement Through a Flexible Sign Bit

FIG. 1 illustrates an example workflow 100 for improved machine learning model operations through a flexible sign bit. In some aspects, the workflow 100 is performed by a machine learning system (e.g., a computing system that trains a machine learning model or uses a trained machine learning model to generate inferences).

The illustrated workflow 100 involves a machine learning model 110 performing certain operations. The machine learning model 110 may be any type of machine learning model that performs one or more operations that produce only non-negative results. Examples of machine learning models include neural networks, transformer neural networks, deep neural networks, tree-based machine learning models such as gradient boosted tree models and random forest models, and/or the like.

In the illustrated example, a value 105 has been encoded using n bits including a sign bit. For example, if an INT4 format is used, then n=4, and the first bit is used as a sign bit for the value 105. The value 105 may, for example, be a value that is generated within a layer of the machine learning model 110 and that is to be normalized. An operation 120 generally represents an operation that produces only non-negative outputs. For example, the operation 120 may be part of a normalization operation. In certain examples, the operation 120 is a square operation, a square root operation, an absolute value operation, or the like. The operation 120 may be implemented in the form of a particular instruction, such as included in the instruction set of a processor such as an NSP.

The operation 120 is performed on the value 105 to produce a result 122. The result 122 is encoded using n bits without using any of the n bits as a sign bit, because the operation 120 produces only non-negative results. For example, in the case of INT4, all 4 bits are used to encode the numerical value of the result 122. Thus, the result 122 is able to be represented with a larger representable range without using a larger bit width.

Optionally, one or more additional operations 130 that may produce negative or non-negative outputs may be performed on the result 122 to produce result(s) 132. According to some aspects, the result(s) 132 are encoded using n bits including a sign bit because the additional operation(s) 130 do not produce only non-negative results.

The result 122 (and/or, in some aspects, the result(s) 132) may be used by the machine learning model 110 to generate an inference (e.g., either during training or when using a trained model). Such an inference will have an increased accuracy due to the result 122 being represented without using any of the n bits as a sign bit and therefore being a more accurate representation of a result of the operation 120.

### Example of Improved Machine Learning Model Operations Through a Flexible Sign Bit

FIG. 2 is an illustration 200 of an example of improved machine learning model operations using a flexible sign bit. The illustration 200 demonstrates representable ranges enabled by a particular bit width (4 bits) in particular cases.

A representable range 210 shows the range of values that can be represented using an INT4 format when both negative and non-negative values are possible. Bits 202, 204, 206, and 208 demonstrate a minimum binary value, 0000, with the bit 202 being used as a sign bit and the bits 204, 206, and 208 representing a numerical value. Bits 212, 214, 216, and 218 demonstrate a maximum binary value, 0111, with the bit 212 being used as a sign bit and the bits 214, 216, and 218 representing a numerical value. Among negative and non-negative values, the representable range 210 is [−8,7].

When only non-negative values are possible (e.g., when performing operations that produce only non-negative results), the representable range 220 demonstrates the representable range using an INT4 format with conventional techniques (e.g., without using a flexible sign bit as described herein). Bits 222, 224, 226, and 228 demonstrate a minimum binary value, 0000, with the bit 222 being used as a sign bit and the bits 224, 226, and 228 representing a numerical value. Bits 232, 234, 236, and 238 demonstrate a maximum binary value, 0111, with the bit 232 being used as a sign bit and the bits 234, 236, and 238 representing a numerical value. Among non-negative values, the representable range 220 is [0,7]. Thus, in cases where negative values are not possible, representable range 220 with conventional techniques provides only a highly restricted representable range of 8 possible values.

Aspects of the present disclosure provide an improved approach that enables an expanded representable range 240 in cases where only non-negative values are possible through the use of a flexible sign bit. When only non-negative values are possible (e.g., when performing operations that produce only non-negative results), the representable range 240 demonstrates the representable range using an INT4 format without using any of the bits as a sign bit. Bits 242, 244, 246, and 248 demonstrate a minimum binary value, 0000, with all of the bits 242, 244, 246, and 248 representing a numerical value and none of these bits being used as a sign bit. Bits 252, 254, 256, and 258 demonstrate a maximum binary value, 1111, with all of the bits 252, 254, 256, and 258 representing a numerical value and none of these bits being used as a sign bit. Among non-negative values, the representable range 240 is [0,15]. Thus, in cases where negative values are not possible, the representable range 240 provides a significantly expanded representable range as compared to the representable range 220 provided by conventional techniques (e.g., when a sign bit is used to represent a value regardless of the type of operation that produces the value).

### Example Additional Enhancement for Improved Machine Learning Model Operations

FIG. 3 is a flow diagram depicting an example enhancement 300 for further improving machine learning model operations in certain aspects.

The enhancement 300 demonstrates a technique for computing the square of an input/in a machine learning model. For example, the enhancement 300 may represent logic implemented by a square instruction used in particular cases, such as in normalization processes.

When I=15, I\hat{ }2=225. In this case, an INT8 format is being used. Thus, the result of the square operation, 225, can be represented in INT8 format using bits 320 as 11100001 (where none of the bits 320 is used as a sign bit).

However, when I is larger than 15, the square of I is outside of the representable range provided by the INT8 format, even without using any bits as a sign bit. For example, if I=16, then the square of 16 is 256, which is above the maximum representable value of 255 allowed by INT8. Thus, according to the enhancement 300, when I>15 (or, more generally, greater than the maximum value B the square S of which can be represented using the available bits), I\hat{ }2 is calculated as S+I−B. Accordingly, when I=16, I\hat{ }2 is calculated as 225+16−15=226. Thus, the result of the square operation, 226, can be represented in INT8 format using bits 330 as 11100010 (where none of the bits 330 is used as a sign bit).

The enhancement 300 allows the machine learning model to differentiate between the results of operations that would otherwise saturate at the maximum representable value, thus providing a higher level of machine learning model accuracy without requiring a larger bit width and the resulting additional costs in memory, processing, and power resources. For example, even though 16\hat{ }2 does not actually equal 226 and 17\hat{ }2 does not actually equal 227, techniques described herein provide some amount of relative differentiation between 16\hat{ }2 and 17\hat{ }2 while conventional techniques would cause both to be represented as the maximum representable value (in this case, 255).

It is noted that while particular examples are described with respect to particular formats such as INT4 and INT8 and particular operations such as square operations and absolute value operations, aspects of the present disclosure are not limited to these particular formats and operations.

### Example Method for Machine Learning Model Improvement Through a Flexible Sign Bit

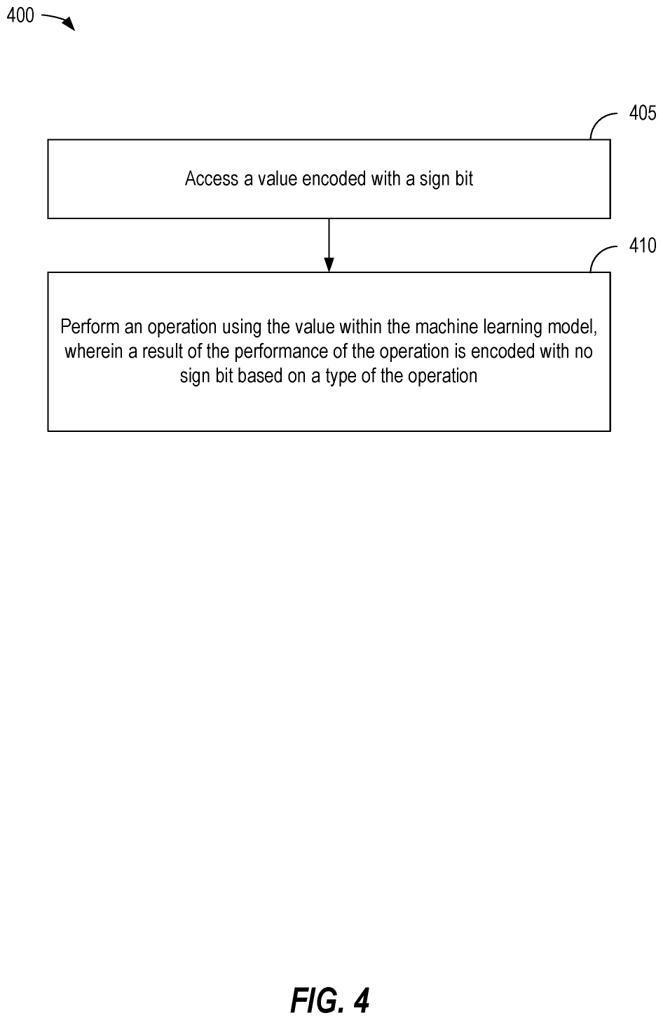

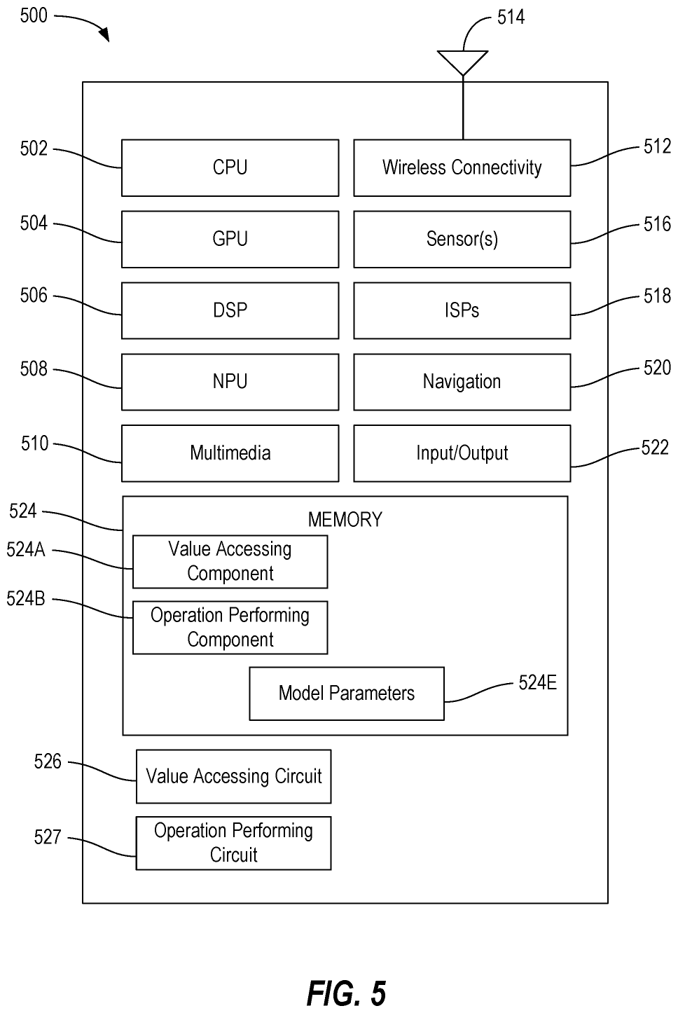

FIG. 4 is a flow diagram depicting an example method 400 for machine learning model improvement. In some aspects, the method 400 is performed by a machine learning model running on a computing system, such as system 500 of FIG. 5, described below.

The method 400 begins at block 405, with accessing a value encoded with a sign bit.

The method 400 continues at block 410, with performing an operation using the value within a machine learning model, wherein a result of the performing of the operation is encoded with no sign bit based on a type of the operation. In certain aspects, the result of the performing of the operation is encoded such that all bits in an encoded representation of the result are used for an unsigned representation of the result. In some aspects, a number of bits of the encoded representation of the result is equal to a corresponding number of bits of the value encoded with the sign bit.

In some aspects, the performing of the operation is part of a normalization process in the machine learning model.

According to certain aspects, the method 400 further comprises storing the result of the performing of the operation encoded with no sign bit (e.g., in association with the machine learning model).

In certain aspects, the type of the operation comprises a square operation or an absolute value operation.

In some aspects, the type of the operation produces exclusively non-negative outputs. In some aspects, the result of the performing of the operation is encoded with no sign bit based on the type of the operation being one that produces exclusively non-negative outputs.

In certain aspects, the method further comprises performing an additional operation using the result of the performing of the operation encoded with no sign bit within the machine learning model, wherein a corresponding result of the performing of the additional operation is encoded with a corresponding sign bit based on a corresponding type of the additional operation. In some aspects, the method further comprises storing the corresponding result of the performing of the additional operation encoded with the corresponding sign bit (e.g., in association with the machine learning model).

In some aspects, the corresponding type of the additional operation produces positive or negative outputs.

In certain aspects, a greater numerical representational range is enabled by encoding the result of the performing of the operation with no sign bit.

In some aspects, the type of the operation is a square operation, and the method further comprises determining that the value is greater than a maximum numerical value a square of which can be precisely represented using an allocated number of bits, and performing the operation by computing an output based on: the square of the maximum numerical value; and a difference between the value and the maximum numerical value. In some aspects, computing the output comprises computing a sum of: the square of the maximum numerical value; and a difference between the value and the maximum numerical value.

In certain aspects, the accessing of the value and the performing of the operation are performed during training of the machine learning model.

In some aspects, the accessing of the value and the performing of the operation are performed as part of generating an inference using the machine learning model.

The method 400 enables an expanded representable range for results of operations of certain types (e.g., that produce only non-negative results) with reduced computational resource cost.

### Example Processing System for Improved Machine Learning Model Operation

In some aspects, the workflows, techniques, and methods described with reference to FIGS. 1-4 may be implemented on one or more devices or systems. FIG. 5 depicts an example processing system 500 configured to perform various aspects of the present disclosure, including, for example, the techniques and methods described with respect to FIGS. 1-4. In some aspects, the processing system 500 may correspond to a machine learning system, such as for training a machine learning model or using a trained machine learning model for inferencing. Although depicted as a single system for conceptual clarity, in some aspects, as discussed above, the operations described below with respect to the processing system 500 may be distributed across any number of devices or systems.

The processing system 500 includes a central processing unit (CPU) 502, which in some examples may be a multi-core CPU. Instructions executed at the CPU 502 may be loaded, for example, from a program memory associated with the CPU 502 or may be loaded from a memory partition (e.g., a partition of memory 524).

The processing system 500 also includes additional processing components tailored to specific functions, such as a graphics processing unit (GPU) 504, a digital signal processor (DSP) 506, a neural processing unit (NPU) 508, a multimedia component 510 (e.g., a multimedia processing unit), and a wireless connectivity component 512.

An NPU, such as NPU 508, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS), as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes a value accessing component 524A and an operation performing component 524B. The memory 524 further includes model parameters 524E for one or more models (e.g., the machine learning model 110 of FIG. 1). Although not included in the illustrated example, in some aspects the memory 524 may also include other data, such as training data (e.g., to train and/or fine-tune the model(s)). Though depicted as discrete components for conceptual clarity in FIG. 5, the illustrated components (and others not depicted) may be collectively or individually implemented in various aspects.

The processing system 500 further comprises a value accessing circuit 526 and an operation performing circuit 527. The depicted circuits, and others not depicted, may be configured to perform various aspects of the techniques described herein.

For example, the value accessing component 524A and/or the value accessing circuit 526 may be used to access a value within a machine learning model, as discussed above, such as a value encoded using a sign bit.

The operation performing component 524B and/or the operation performing circuit 527 may be used to perform an operation on the value accessed by value accessing component 524A and/or the value accessing circuit 526, such as the operation 120 of FIG. 1 and/or, in some aspects, the enhancement 300 of FIG. 3. For example, the operation performing component 524B and/or the operation performing circuit 527 may perform an operation that produces only non-negative results, such as during a normalization process in a machine learning model. A result of performing the operation by the operation performing component 524B and/or the operation performing circuit 527 may be encoded without using any bit as a sign bit. For example, as described above, all available bits may be used for an unsigned representation of a result of the operation (because the operation produces only non-negative results), thus providing an expanded representable range without requiring a larger bit width and corresponding costs in memory, processing, and power resources of system 500.

Though depicted as separate components and circuits for clarity in FIG. 5, the value accessing circuit 526 and the operation performing circuit 527 may collectively or individually be implemented in other processing devices of the processing system 500, such as within the CPU 502, the GPU 504, the DSP 506, the NPU 508, and the like. For example, the value accessing circuit 526 and/or the operation performing circuit 527 may implemented via one or more instructions in an instruction set of the CPU 502, the GPU 504, the DSP 506, the NPU 508, or the like.

Generally, the processing system 500 and/or components thereof may be configured to perform the methods described herein.

Notably, in other aspects, elements of the processing system 500 may be omitted, such as where the processing system 500 is a server computer or the like. For example, the multimedia component 510, the wireless connectivity component 512, the sensor processing units 516, the ISPs 518, and/or the navigation processor 520 may be omitted in other aspects. Further, aspects of the processing system 500 may be distributed between multiple devices.

### Example Clauses

Implementation examples are described in the following numbered clauses:

Clause 1: A processing system comprising: one or more memories storing processor-executable instructions; and one or more processors configured to execute the processor-executable instructions and cause the processing system to: access a value encoded with a sign bit; and perform an operation using the value within a machine learning model, wherein a result of the performance of the operation is encoded with no sign bit based on a type of the operation.

Clause 2: The processing system of Clause 1, wherein the performance of the operation is part of a normalization process in the machine learning model.

Clause 3: The processing system of any one of Clause 1-2, wherein the result of the performance of the operation is encoded such that all bits in an encoded representation of the result are used for an unsigned representation of the result.

Clause 4: The processing system of Clause 3, wherein a number of bits of the encoded representation of the result is equal to a corresponding number of bits of the value encoded with the sign bit.

Clause 5: The processing system of any one of Clause 1-4, wherein the type of the operation comprises a square operation or an absolute value operation.

Clause 6: The processing system of any one of Clause 1-5, wherein the type of the operation produces exclusively non-negative outputs.

Clause 7: The processing system of Clause 6, wherein the one or more processors are further configured to execute the processor-executable instructions and cause the processing system to: perform an additional operation using the result of the performance of the operation encoded with no sign bit within the machine learning model, wherein a corresponding result of the performance of the additional operation is encoded with a corresponding sign bit based on a corresponding type of the additional operation.

Clause 8: The processing system of Clause 7, wherein the corresponding type of the additional operation produces positive or negative outputs.

Clause 9: The processing system of any one of Clause 1-8, wherein the type of the operation is a square operation, and wherein the one or more processors are further configured to execute the processor-executable instructions and cause the processing system to: determine that the value is greater than a maximum numerical value a square of which can be precisely represented using an allocated number of bits; and perform the operation by computing an output based on: the square of the maximum numerical value; and a difference between the value and the maximum numerical value.

Clause 10: The processing system of any one of Clause 1-9, wherein the access of the value and the performance of the operation are performed during training of the machine learning model.

Clause 11: The processing system of any one of Clause 1-10, wherein the access of the value and the performance of the operation are performed as part of a generation of an inference using the machine learning model.

Clause 12: A method for improved machine learning model operations, comprising: accessing a value encoded with a sign bit; and performing an operation using the value within a machine learning model, wherein a result of the performance of the operation is encoded with no sign bit based on a type of the operation.

Clause 13: The method of Clause 12, wherein the performance of the operation is part of a normalization process in the machine learning model.

Clause 14: The method of any one of Clause 12-13, wherein the result of the performance of the operation is encoded such that all bits in an encoded representation of the result are used for an unsigned representation of the result.

Clause 15: The method of Clause 14, wherein a number of bits of the encoded representation of the result is equal to a corresponding number of bits of the value encoded with the sign bit.

Clause 16: The method of any one of Clause 12-15, wherein the type of the operation comprises a square operation or an absolute value operation.

Clause 17: The method of any one of Clause 12-16, wherein the type of the operation produces exclusively non-negative outputs.

Clause 18: The method of Clause 17, further comprising: performing an additional operation using the result of the performance of the operation encoded with no sign bit within the machine learning model, wherein a corresponding result of the performance of the additional operation is encoded with a corresponding sign bit based on a corresponding type of the additional operation.

Clause 19: The method of Clause 18, wherein the corresponding type of the additional operation produces positive or negative outputs.

Clause 20: An apparatus, comprising: means for accessing a value encoded with a sign bit; and means for performing an operation using the value within a machine learning model, wherein a result of the performance of the operation is encoded with no sign bit based on a type of the operation.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories storing processor-executable instructions; and
one or more processors configured to execute the processor-executable instructions and cause the processing system to:
access a value encoded with a sign bit; and
perform an operation using the value within a machine learning model, wherein a result of the performance of the operation is encoded with no sign bit based on a type of the operation.

2. The processing system of claim 1, wherein the performance of the operation is part of a normalization process in the machine learning model.

3. The processing system of claim 1, wherein the result of the performance of the operation is encoded such that all bits in an encoded representation of the result are used for an unsigned representation of the result.

4. The processing system of claim 3, wherein a number of bits of the encoded representation of the result is equal to a corresponding number of bits of the value encoded with the sign bit.

5. The processing system of claim 1, wherein the type of the operation comprises a square operation or an absolute value operation.

6. The processing system of claim 1, wherein the type of the operation produces exclusively non-negative outputs.

7. The processing system of claim 6, wherein the one or more processors are further configured to execute the processor-executable instructions and cause the processing system to:
perform an additional operation using the result of the performance of the operation encoded with no sign bit within the machine learning model, wherein a corresponding result of the performance of the additional operation is encoded with a corresponding sign bit based on a corresponding type of the additional operation.

8. The processing system of claim 7, wherein the corresponding type of the additional operation produces positive or negative outputs.

9. The processing system of claim 1, wherein the type of the operation is a square operation, and wherein the one or more processors are further configured to execute the processor-executable instructions and cause the processing system to:
determine that the value is greater than a maximum numerical value a square of which can be precisely represented using an allocated number of bits; and
perform the operation by computing an output based on:
the square of the maximum numerical value; and
a difference between the value and the maximum numerical value.

10. The processing system of claim 1, wherein the access of the value and the performance of the operation are performed during training of the machine learning model.

11. The processing system of claim 1, wherein the access of the value and the performance of the operation are performed as part of a generation of an inference using the machine learning model.

12. A method for improved machine learning model operations, comprising:
accessing a value encoded with a sign bit; and
performing an operation using the value within a machine learning model, wherein a result of the performance of the operation is encoded with no sign bit based on a type of the operation.

13. The method of claim 12, wherein the performance of the operation is part of a normalization process in the machine learning model.

14. The method of claim 12, wherein the result of the performance of the operation is encoded such that all bits in an encoded representation of the result are used for an unsigned representation of the result.

15. The method of claim 14, wherein a number of bits of the encoded representation of the result is equal to a corresponding number of bits of the value encoded with the sign bit.

16. The method of claim 12, wherein the type of the operation comprises a square operation or an absolute value operation.

17. The method of claim 12, wherein the type of the operation produces exclusively non-negative outputs.

18. The method of claim 17, further comprising:
performing an additional operation using the result of the performance of the operation encoded with no sign bit within the machine learning model, wherein a corresponding result of the performance of the additional operation is encoded with a corresponding sign bit based on a corresponding type of the additional operation.

19. The method of claim 18, wherein the corresponding type of the additional operation produces positive or negative outputs.

20. An apparatus, comprising:
means for accessing a value encoded with a sign bit; and
means for performing an operation using the value within a machine learning model, wherein a result of the performance of the operation is encoded with no sign bit based on a type of the operation.
